(19) United States
(12) Patent Application Publication
(10) Pub. No.: US 2015/0220294 A1
(43) Pub. Date: Aug. 6, 2015

(54) FLAT PANEL DISPLAY

(71) Applicant: SHENZHEN CHINA STAR OPTOELECTRONICS TECHNOLOGY CO., LTD., Shenzhen, Guangdong (CN)

(72) Inventors: Hua Zheng, Shenzhen (CN); Chenghung Chen, Shenzhen (CN)

(73) Assignee: SHENZHEN CHINA STAR OPTOELECTRONICS TECHNOLOGY CO., LTD, Shenzhen (CN)

(21) Appl. No.: 13/985,580

(22) PCT Filed: Jun. 27, 2013
(86) PCT No.: PCT/CN2013/078119

§ 371 Date: Aug. 15, 2013

(30) Foreign Application Priority Data
Mar. 26, 2013 (CN) 201310101076.9

(51) Int. Cl. G06F 3/147; H04N 5/70; G09G 3/20; G09G 3/32; G09G 3/36

(52) U.S. Cl. CPC G06F 3/147; G09G 3/3258; G09G 3/3659; G09G 3/3208; G09G 3/36; G09G 3/2003; G09G 3/3611; H04N 5/70; G09G 2300/0809; G09G 2310/0227; G09G 2340/0457; G09G 2340/16

(57) ABSTRACT

A flat panel display includes scan lines, data lines, and pixels. Each pixel including at least one first subpixel and a second subpixel, the first subpixel and the second subpixel of the pixel are coupled different scan lines but coupled to the same data line. All of the first subpixels of the pixels are scanned in a first display period, and all of the second subpixels of the pixels are scanned in a second display period after all of the first subpixels are scanned. One color of subpixel is scanned at a time in the flat panel display featuring interlaced scanning. Because video data does not change obviously in general, video data of the single one color of subpixel does not obviously change. The data line is not overloaded, neither. In this way, the color cast occurring in the conventional technology does not happen anymore.

### BACKGROUND OF THE INVENTION

1. Field of the Invention

The present invention relates to a flat panel display, and more particularly, to a flat panel display adopting a special scanning method.

2. Description of the Prior Art

With a rapid development of monitor types, novelty and colorful monitors with high resolution, e.g., liquid crystal displays (LCDs), are indispensable components used in various electronic products such as monitors for notebook computers, personal digital assistants (PDA), digital cameras, and projectors. The demand for the novelty and colorful monitors has increased tremendously.

Please refer to FIG. 1 showing a schematic diagram of a conventional liquid crystal display (LCD) 100. The LCD 100 comprises an LCD panel 110, a gate driver 120, and a source driver 130. The LCD panel 110 comprises a plurality of pixels 140, a plurality of scan lines GL, and a plurality of data lines DL. Each of the plurality of pixels comprises three colors of RGB subpixels 141.

The RGB subpixels 141 comprise two manners of arrangement, as shown in FIG. 1. One is a vertical arrangement and the other is horizontal arrangement. Referring to FIG. 2, FIG. 2 shows the two manners of arrangement. The horizontal arrangement means that the ROB subpixels 141 are arranged in a horizontal arrangement. The ROB subpixels 141 correspond to their respective data lines DL while corresponding to an identical scan line GL. A 3D1G arrangement is defined based on the number of the data line DL and the scan line GL which the ROB subpixels 141 correspond to. On the other hand, the vertical arrangement means that the ROB subpixels 141 are arranged in a vertical arrangement. The ROB subpixels 141 correspond to their respective scan lines GL while corresponding to an identical data line DL. A 3G1D arrangement (i.e., tri-gate pixel arrangement) is defined based on the number of the data line DL and scan line GL which the ROB subpixels 141 corresponds to.

Refer to FIG. 3 showing a driving method of a conventional panel using the 3G1D pixel structure. The conventional panel using the 3G1D pixel structure adopts an image scanning technique—one-by-one scanning during a time period T of a frame. For example, at first, a first scan line G(1) is conducted to be scanned. At this time, data voltage applied on the data line is transmitted to a first row of subpixels (red subpixels R); that is, voltage applied on D(x) is transmitted to R(x,1). Next, a second scan line G(2) is conducted to be scanned. At this time, the data voltage applied on the data line is transmitted to a second row of subpixels (green subpixels G); that is, the voltage applied on D(x) is transmitted to G(x,l), and so forth. Scanning will operate repeatedly until a last 3N scan line G(3N) is conducted. Meanwhile, the voltage applied on the data line is transmitted to a 3N row of subpixels (blue subpixels B); that is, the voltage applied on D(x) is transmitted to B(x,N).

However, the method of one-by-one scanning tends to make the plurality of data lines overloaded, causing the subpixels to be charged abnormally and to have the color cast. Refer to FIG. 4A and FIG. 4B showing the data voltage output by the conventional source driver 130 and the difference between voltages applied on each of the subpixels after being charged practically. A polarity of the data voltage from the source driver 130 with respect to common voltage from a common electrode is inverted in each frame, and the color displayed is yellow (grey level (255, 255, 0)). Thus, the data voltage output by the source driver 130 is shown in FIG. 4A where the R, G, and B sections represent the data voltage which should be transmitted to the red, green, and blue subpixels, respectively. However, due to RC delay and sharp variation between two adjacent scan lines (from 0 to 255 or from 255 to 0), a waveform of the data voltage transmitted to the red, green, and blue subpixels are practically shown in FIG. 4B. The red subpixel is charged inadequately, the green subpixel is charged normally, and the blue subpixel is slightly mischarged, causing the color cast (blue shift) to occur in the frame, as shown in FIG. 4B. In addition, the farther an area from the source driver, the more serious the color cast becomes due to RC delay.

Therefore, the industry tries hard to develop a new method for solving the problem with the color cast mentioned above.

### SUMMARY OF THE INVENTION

Therefore, an object of the present invention is to provide a flat panel display featuring interlaced scanning to solve the problem with the color cast occurring in the conventional technology.

According to the present invention, a flat panel display comprises a plurality of scan lines, a plurality of data lines, and a plurality of pixels. Each of the plurality of pixels comprises at least one first subpixel and a second subpixel. The first subpixel of each of the plurality of pixels is coupled to one of the plurality of scan lines. The second subpixel of each of the plurality of pixels is coupled to one of the plurality of scan lines. The two scan lines are different from each other. The first subpixel of each of the plurality of pixels is coupled to one of the plurality of data lines. The second subpixel of each of the plurality of pixels is coupled to one of the plurality of data lines. The two data lines are identical. All of the first subpixels of the plurality of pixels are scanned in a first display period, and all of the second subpixels of the plurality of pixels are scanned in a second display period after all of the first subpixels are scanned.

In one aspect of the present invention, each of the plurality of pixels further comprises a third subpixel. The third subpixel is coupled to one of the plurality of scan lines which is different from the scan lines which the first and second subpixels are coupled to, and the third subpixel of each of the plurality of pixels is coupled to one of the plurality of data lines which is identical to the data line which the first and second subpixels are coupled to. All of the third subpixels of the plurality of pixels are scanned in a third display period after all of the second subpixels are scanned.

In another aspect of the present invention, the first subpixel, the second subpixel, and the third subpixel correspond to different colors.

In still another aspect of the present invention, the first subpixel is a red subpixel, the second subpixel is a green subpixel, and the third subpixel is a blue subpixel.

In still another aspect of the present invention, duration of the first display period, duration of the second display period, and duration of the third display period are identical. In still another aspect of the present invention, duration of the first display period and duration of the second display period are identical.

In yet another aspect of the present invention, the flat panel display is a liquid crystal display or an organic light emitting diode display.

According to the present invnetion, a flat panel display with a resolution of M×N, comprises M×kN subpixels, k×N scan lines, and M data lines. M, N, and k are positive integers. Each of the scan lines controlling a row of subpixels. Each of the data lines controls a column of subpixels. Firstly, M×N subpixels corresponding to a first color are sequentially scanned via N of the kN scan lines, next, another M×N subpixels corresponding to a second color are sequentially scanned via another N of the kN scan lines, and the operation of scanning other M×(k−2) N subpixels repeats until all of the M×kN subpixels are scanned.

In still another aspect of the present invention, the M×N subpixels are scanned by the flat panel display in al/k display period.

In still another aspect of the present invention, the flat panel display is a liquid crystal display or an organic light emitting diode display.

Compared with the conventional technology, one color of subpixel is scanned at a time in the flat panel display featuring interlaced scanning in the present invention. Because video information does not change obviously in general in the present flat panel display, video information of the single color of subpixel does not obviously change. The plurality of data lines are not overloaded, neither. In this way, the color cast occurring in the conventional technology no more happens.

These and other objectives of the present invention will become apparent to those of ordinary skilled in the art after reading the following detailed description of the preferred embodiment that is illustrated in the various figures and drawings.

### BRIEF DESCRIPTION OF THE DRAWINGS

FIG. 1 shows a schematic diagram of a conventional liquid crystal display.

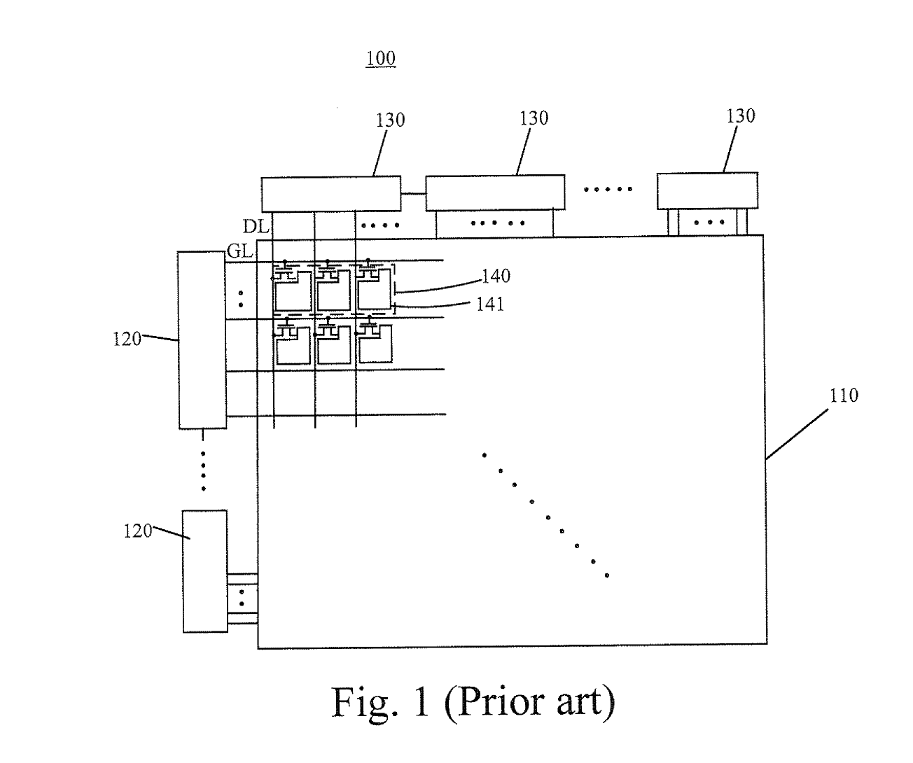

FIG. 2 shows the two manners of arrangement.

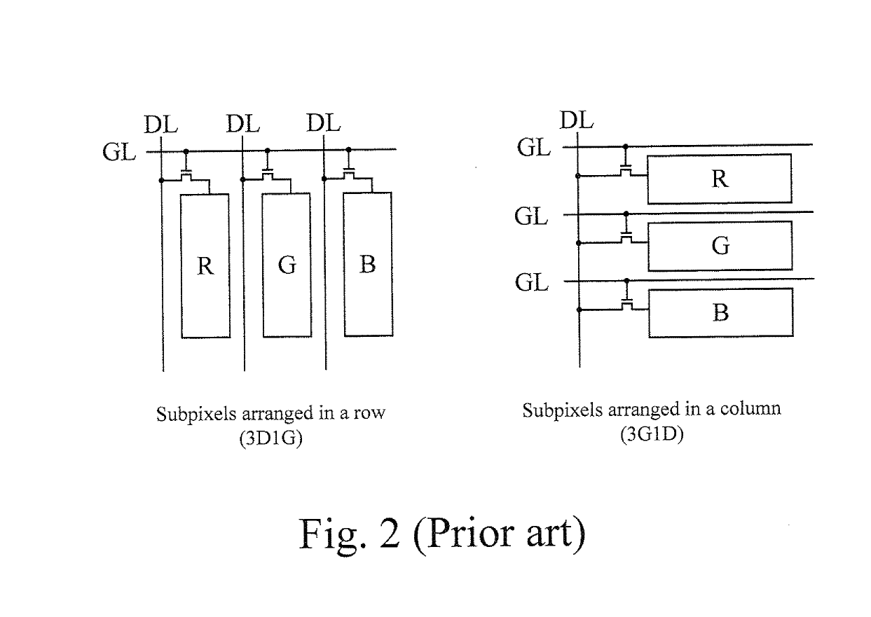

FIG. 3 shows a driving method of a conventional panel using the 3G1D pixel structure.

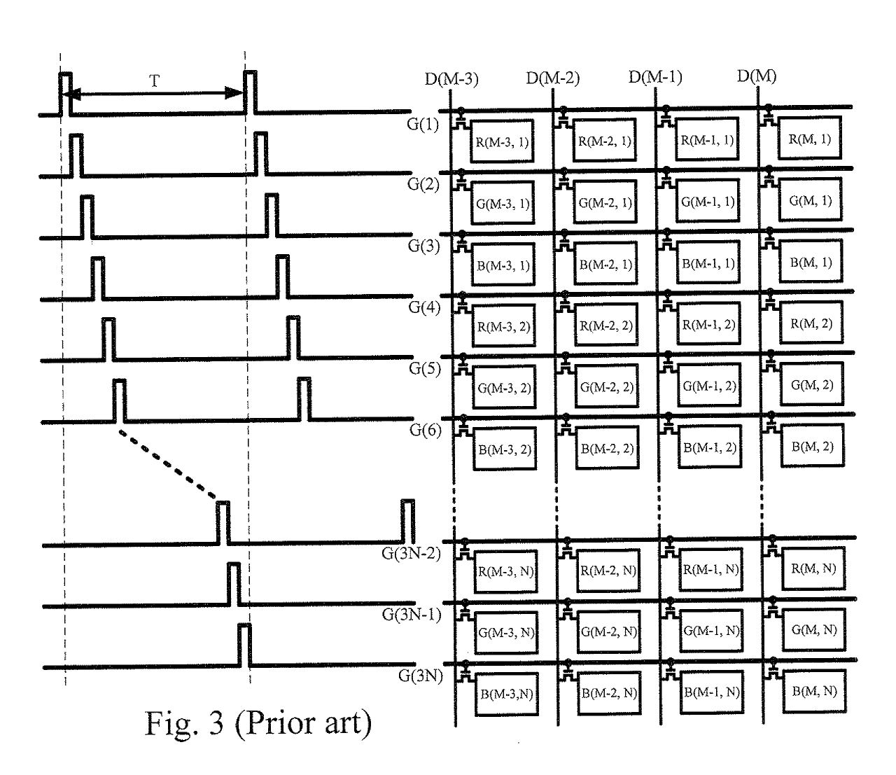

FIG. 4A and FIG. 4B show the data voltage output by the conventional source driver and the difference between voltages applied on each of the subpixels after being charged practically.

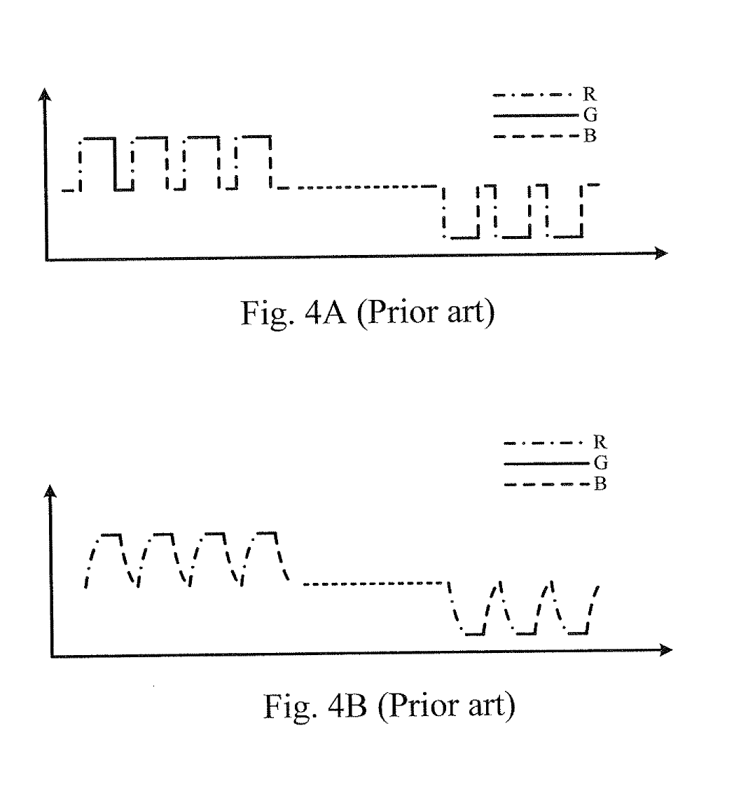

FIG. 5 shows a driving method of a panel using the 3G1D pixel structure according to one embodiment of the present invention.

FIG. 6A and FIG. 6B show the data voltage output by the source driver and the difference between voltages applied on each of the subpixels after being charged practically according to the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

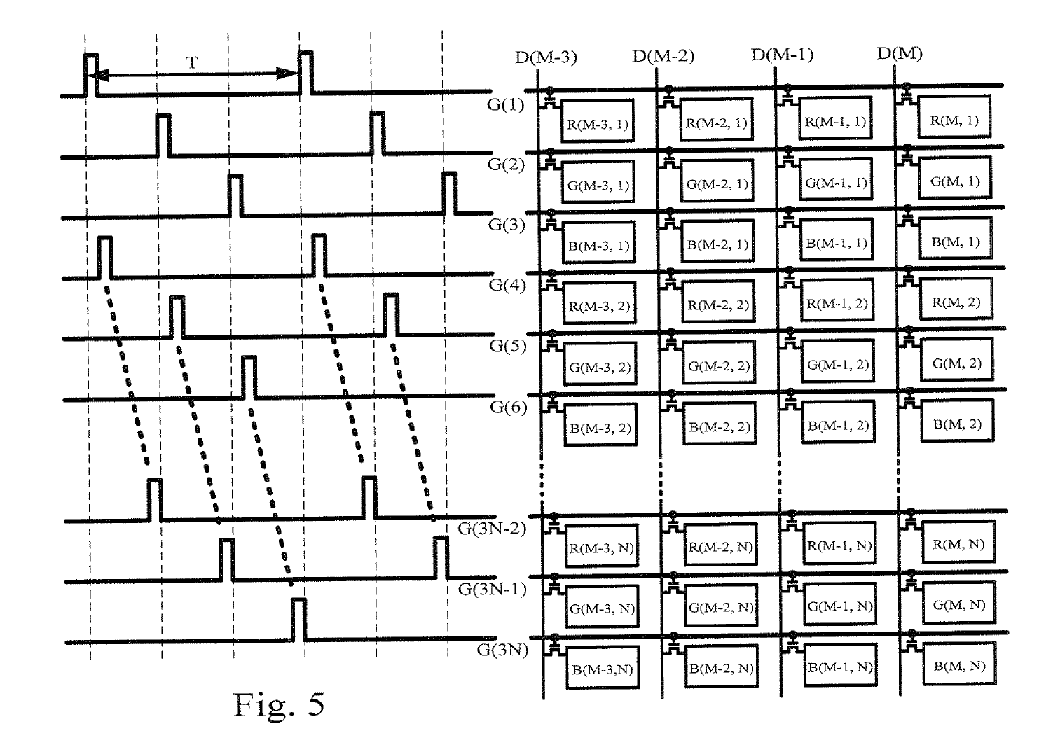

Refer to FIG. 5 showing a driving method of a panel using the 3G1D pixel structure according to one embodiment of the present invention. It is notified that this embodiment adopts the driving method of interlaced scanning instead of the conventional one-by-one scanning.

At first, all of the red subpixels R are interlacedly scanned by an LCD of the present invention during a first 1/3×T time period during a time period T of a frame. Firstly, a first scan line G(1) is conducted. Meanwhile, data voltage applied on a data line is transmitted to a first row of red subpixels R; that is, voltage applied on D(x) is transmitted to R(x,1). Next, a fourth scan line G(4) is conducted. At this time, the data voltage applied on the data line is transmitted to a fourth row of red subpixels R; that is, the voltage applied on D(x) is transmitted to R(x,2), and so forth. Scanning will repeat until the last 3N-2 scan line G(3N-2) is conducted where N indicates the total pixels in a vertical direction. At this time, the data voltage applied on the data line is transmitted to the 3N-2 row of red subpixels R; that is, the voltage applied on D(x) is transmitted to R(x,N). Finally, all of the red subpixels R are scanned completely.

Afterwards, all of the green subpixels G are interlacedly scanned by the LCD during a second 1/13×T time period. Firstly, a second scan line G(2) is conducted. Meanwhile, data voltage applied on the data line is transmitted to a second row of green subpixels G; that is, voltage applied on D(x) is transmitted to G(x,1). Next, a fifth scan line G(5) is conducted. At this time, the data voltage applied on the data line is transmitted to a fifth row of green subpixels G; that is, the voltage applied on D(x) is transmitted to G(x,2), and so on. Scanning will repeat until the last 3N-1 scan line G(3N-1) is conducted where N indicates the total pixels in the vertical direction. At this time, the data voltage applied on the data line is transmitted to the 3N-1 row of green subpixels G; that is, the voltage applied on D(x) is transmitted to G(x,N). Finally, all of the green subpixels G are scanned completely.

Afterwards, all of the blue subpixels B are interlacedly scanned by the LCD during the last 1/3×T time period after the red subpixels R and the green subpixels G are all scanned.

Firstly, a third scan line G(3) is conducted. Meanwhile, data voltage applied on the data line is transmitted to a third row of blue subpixels B; that is, voltage applied on D(x) is transmitted to B(x,1). Next, a sixth scan line G(6) is conducted. At this time, the data voltage applied on the data line is transmitted to a sixth row of blue subpixels B; that is, the voltage applied on D(x) is transmitted to B(x,2), and so forth. Scanning will repeat until the last 3N scan line

G(3N) is conducted where N indicates the total pixels in the vertical direction. At this time, the data voltage applied on the data line is transmitted to the 3N row of blue subpixels B; that is, the voltage applied on D(x) is transmitted to B(x,N). Finally, all of the blue subpixels B are scanned completely. At this stage, a frame finishes being scanned.

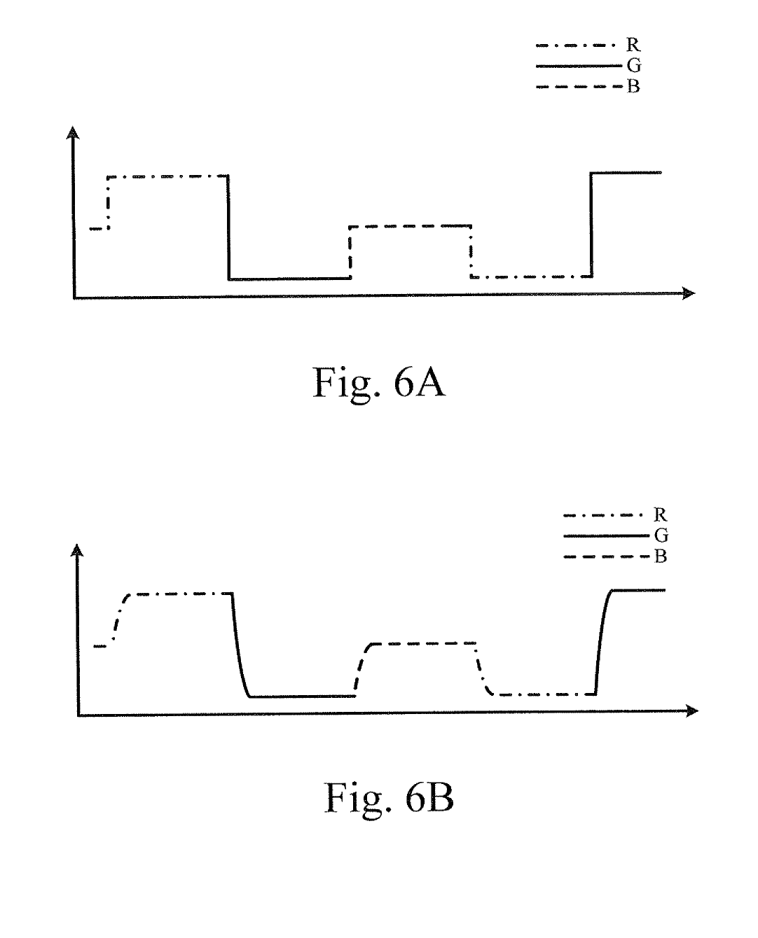

By using the method of one-by-one scanning, the data line is overloaded and each of the subpixels is charged normally, which ensures that color cast does not occur. Refer to FIG. 6A and FIG. 6B. FIG. 6A shows a waveform of the data voltage output by a source driver when an image output by the LCD panel has arbitrarily mixed colors. In the FIG. 6A, R, G, and B sections represents the data voltage which should be transmitted to the red, green, and blue subpixels, respectively. FIG. 6B shows a real waveform of the voltage applied on the red, green, and blue subpixels after the subpixels are charged. Even if a propagation delay exists, causing the pixels in the first row and the last row to be charged abnormally, the other pixels are charged normally, as shown in FIG. 6B. The color cast will not be observed when a viewer watches the whole image.

According to what is disclosed, the interlaced scanning adopted by the present invention can be done in a timing controller. The timing controller outputs a controlling signal to a gate driver, and the gate driver switches on the scan lines by using the above-mentioned interlaced scanning. The data which the scan lines correspond to is also output by the timing controller. For example, the timing controller temporarily stores the one-by-one scanned data to a buffer and rearranges the data to generate new data for interlaced scanning. Then, the timing controller outputs the new data to the source driver.

It is notified that the present invention is not restricted to the LCD. The above-mentioned LCD is one of the embodiments of the present invention. Practically, the concept of the present invention can be applied to an active-matrix organic light-emitting diode (AMOLED) display. Change and modification within the scope of the present invention may be made.

Although the 3G1D display is exemplified in the above-mentioned embodiment, the present invention is not restricted to the 3G1D display. Practically, the concept of the present invention can be applied to an nG1D display panel, such as a 4G1D panel comprising red, green, blue, and white (RGBW) subpixels. It is notified that the present invention could be embodied in many other specific forms without departing from the spirit or the scope of the present invention.

Although the subpixel of the same color is updated in an order of red, green, and blue in the above-mentioned embodiment, the present invention is not restricted to the order. Practically, the present invention adopts other orders. Change and modification within the scope of the present invention may be made.

Compared with the prior art, one color of subpixel is scanned at a time in the flat panel display featuring interlaced scanning. Because video data does not change obviously in general in the present flat panel display, video data of the single one color of subpixel does not obviously change. The data line is not overloaded, neither. In this way, the color cast occurring in the conventional technology does not happen anymore.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

what is claimed is:

1. A flat panel display, comprising:
a plurality of scan lines and a plurality of data lines;
a plurality of pixels, each of the plurality of pixels comprising at least one first subpixel and a second subpixel, the first subpixel of each of the plurality of pixels coupled to one of the plurality of scan lines, the second subpixel of each of the plurality of pixels coupled to one of the plurality of scan lines, the two scan lines being different from each other, the first subpixel of each of the plurality of pixels coupled to one of the plurality of data lines, the second subpixel of each of the plurality of pixels coupled to one of the plurality of data lines, and the two data lines being identical;
wherein all of the first subpixels of the plurality of pixels are scanned in a first display period, and all of the second subpixels of the plurality of pixels are scanned in a second display period after all of the first subpixels are scanned.

2. The flat panel display as claimed in claim 1, wherein each of the plurality of pixels further comprises a third subpixel, the third subpixel is coupled to one of the plurality of scan lines which is different from the scan lines which the first and second subpixels are coupled to, and the third subpixel of each of the plurality of pixels is coupled to one of the plurality of data lines which is identical to the data line which the first and second subpixels are coupled to, whererin all of the third subpixels of the plurality of pixels are scanned in a third display period after all of the second subpixels are scanned.

3. The flat panel display as claimed in claim 2, wherein the first subpixel, the second subpixel, and the third subpixel correspond to different colors.

4. The flat panel display as claimed in. claim 3, wherein the first subpixel is a red subpixel, the second subpixel is a green subpixel, and the third subpixel is a blue subpixel.

5. The flat panel display as claimed in claim 2, wherein duration of the first display period, duration of the second display period, and duration of the third display period are identical.

6. The flat panel display as claimed in claim 1, wherein duration of the first display period and duration of the second display period are identical.

7. The flat panel display as claimed in claim 1 being a liquid crystal display or an organic light emitting diode display.

8. A flat panel display, comprising a resolution of M×N, comprising:
M×kN subpixels, M, N, and k being positive integers;
k×N scan lines, each of the scan lines controlling a row of subpixels; and
M data lines, each of the data lines controlling a column of subpixels;
wherein firstly, M×N subpixels corresponding to a first color are one-by-one scanned via N of the kN scan lines, next, another M×N subpixels corresponding to a second color are one-by-one scanned via another N of the kN scan lines, and the operation of scanning other M×(k−2) N subpixels repeats until all of the M×kN subpixels are scanned.

9. The flat panel display as claimed in claim 8, wherein the M×N subpixels are scanned in al/k display period.

10. The flat panel display as claimed in claim 8 being a liquid crystal display or an organic light emitting diode display.
